(19) United States
(12) Patent Application Publication
(10) Pub. No.: US 2008/0127581 A1
(43) Pub. Date: Jun. 5, 2008

(54) Security window insert assembly

(76) Inventor: Nick Walters, Baltimore, MD (US)

Correspondence Address: Ober, Kaler, Grimes & Shriver;Royal W. Craig, 120 East Baltimore Street, Baltimore, MD, 21202-1643, US

(21) Appl. No.: 11/897,789

(22) Filed: Aug. 31, 2007

Related U.S. Application Data
(60) Provisional application No. 60/841,613, filed on Aug. 31, 2006.

(51) Int. Cl. E06B 3/988

(52) U.S. Cl. 52/204.71

(57) ABSTRACT

The present invention is a security window insert assembly retrofit to existing insulated windows (double or other multi-pane windows). The assembly generally comprises a tubular steel gridwork anchored in a substantially rectangular spacer, and opposing panes of glass adhered to the sides of the spacer such that the gridwork occupies and is suspended in the airspace between the panes of glass. The tubular gridwork comprises a gridwork of or more horizontal and one or more vertical struts leading to distal ends press-fit into the spacer. The result is a double pane window unit that may be installed within a window frame in a conventional manner. However, the security grating erects an impenetrable shield between the interior surfaces of the panes, and since it remains anchored in the spacers it cannot be removed.

### CROSS-REFERENCE TO RELATED APPLICATION(S)

The present application derives priority from U.S. provisional application No. 60/841,613 filed 29 Aug. 2006.

### BACKGROUND OF THE INVENTION

1. Field of the Invention

The present invention generally relates to security windows, and more particularly to a security window insert assembly for existing double pane windows.

2. Description of the Background

Standard single-pane windows have minimal insulating value. Consequently, to improve a window's energy efficiency it is typical to increase the number of glass panes in the unit. Today most “insulated windows” are double- or triple-pane windows with insulating air- or gas-filled spaces between each pane. Each pane of glass and the air spaces resist heat flow. The ideal width of air spaces is between ½ and ⅝ inches. The width of the air spaces between the panes is important because air spaces that are too wide (more than ⅝ inch or 1.6 centimeters) or too narrow (less than ½ inch or 1.3 centimeters) have lower “R-values” (i.e., they allow too much heat transfer). To establish the proper spacing, spacers are used to separate the multiple panes of glass within the windows. These spacers are generally rectangular frames that are inserted between the window panes to space the glass, without obstructing the view. These rectangular spacers also serve to seal the air or gas-space between the panes. Many multi-pane windows are filled with nitrogen between the panes to avoid condensation. The nitrogen-filled space is sealed by including seals or sealant between the spacers and glass panes.

There are a variety of different spacer configurations, most are metal (specifically aluminum) since plastic fares poorly between closed panes. The metal spacers are typically four end-joined struts welded together in a rectangle or, alternatively, a single elongate strut notched four times along its length and folded into a rectangular frame. Metal struts are usually hollow, having a U-shaped or similar cross-section with opposing sides that fit between the panes. A dessicant is often coated into the interior of the spacers to reduce condensation. During assembly, the glass panes are bonded on opposing sides of a spacer by sealant, or Butyl rubber seals that conform to the spacers are bonded between the spacers and the glass panes (around the periphery of the panes). The result is an “insulated window”, e.g., a multi-pane window unit (here a double pane) that may be installed within a window frame.

Many residential windows are also equipped with window grid inserts to give their windows a more traditional appearance. These grid inserts are most-often formed as plastic matrices with tips that snap-fit into sockets outside the window panes, purely for decorative effect. It is now common to fit aluminum window grids between the panes for aesthetic effect, sealing them in the central airspace to avoid dust collection and making cleaning much easier. In either case the aesthetic effect is very important to consumers. However, aesthetics should not be the only concern. Security is also a primary concern to most homeowners, many of whom are not satisfied with the security a standard insulated window offers. To increase security it was heretofore necessary to install metal security bars overtop the windows. Security bars must be sufficiently affixed to windows to prevent criminals from removing the bars and entering through the windows, and they are commonly affixed exteriorly to the window frame to prevent break-ins. However these security bars are subject to rust and corrosion, and are unsightly and difficult to install. Moreover, they effectively prevent any escape in the event of a fire or other emergency.

It would be greatly advantageous to provide a security window insert assembly for existing insulated windows that: 1) increases aesthetics of the windows and incorporates a secure, impenetrable grating between the window panes for security; 2) forms a tight fit between double panes of insulated glass to prevent removal; 3) is inexpensive to manufacture and easy to install during the window manufacturing process within the footprint of existing double pane windows, thereby providing for widespread consumer use.

### SUMMARY OF THE INVENTION

It is, therefore, a primary object of the present invention to provide a security window insert assembly that retrofits to conventional insulated window (double or other multi-pane) to prevent break-ins and at the same time add to the aesthetics of said windows.

Yet another object of the present invention to provide a security window insert assembly comprising a grating and inserts anchored between the panes of insulated windows to prevent break-ins through windows.

Yet another object of the present invention is to provide a security window insert assembly that is relatively lightweight and easy to manufacture.

These and other objects are accomplished by a security window insert assembly for installation into conventional insulated windows. The windows are of a conventional type having a frame, and multi-pane insert(s) slidably seated in the frame. Each insert further comprises a rectangular spacer bonded between panes of glass, with sealant or more preferably Butyl-rubber seals interposed between the spacer and glass panes. In accordance with the present invention, the security window insert assembly comprises a tubular steel gridwork anchored in the spacers and resident within the airspace between the panes of glass. The tubular gridwork comprises one or more horizontal and one or more vertical struts integrally joined at their intersection, with protruding distal ends fixedly anchored in the spacer. During assembly, the spacer is applied about the security window insert assembly such that the security window insert assembly is anchored therein. The panes of glass are bonded on opposing sides of the spacer by sealant, or more preferably Butyl rubber seals that conform to the spacers and which are bonded between the spacers and the glass panes (around the periphery of the panes). The result is a double pane window unit that may be installed within a window frame in a conventional manner. However, the security grating erects an impenetrable shield between the interior surfaces of the panes, and since it remains anchored in the spacers it cannot be removed.

When installed in a conventional double-hung double-pane window, both top and bottom sliders would incorporate a security window insert assembly. The inner perimeter of each grating fits the existing footprint of each slider, and the inserts may be slidably seated within the window frame in a conventional manner. Thus, when the sliders are locked together using their existing locking mechanism the adjoining insert assemblies create a secure and tamper-proof shield against forced entry.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a perspective view of the security window insert assembly 1.

FIG. 2 is an assembly drawing of the security window insert assembly 1.

FIG. 3 is a side cross-section of the security window insert assembly 1.

FIG. 4 is a top perspective view of the security window insert assembly 1.

FIG. 5 is an end perspective view of the grating 2 and buffer pads 12.

FIG. 6 is a bottom perspective view of the grating 2 mounted between double pane windows 5, 6.

### DETAILED DESCRIPTION OF THE PREFERRED EMBODIMENT

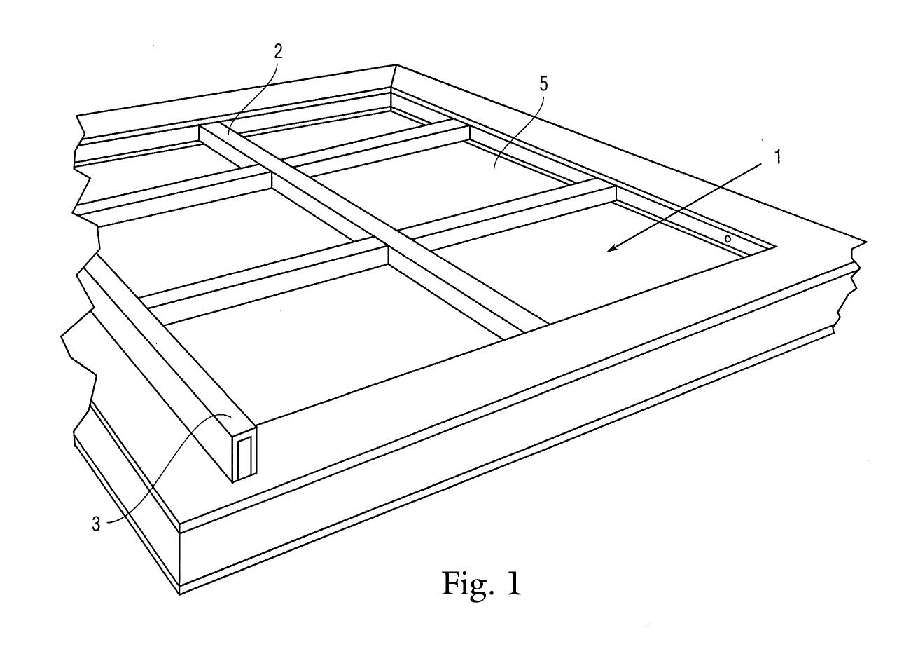

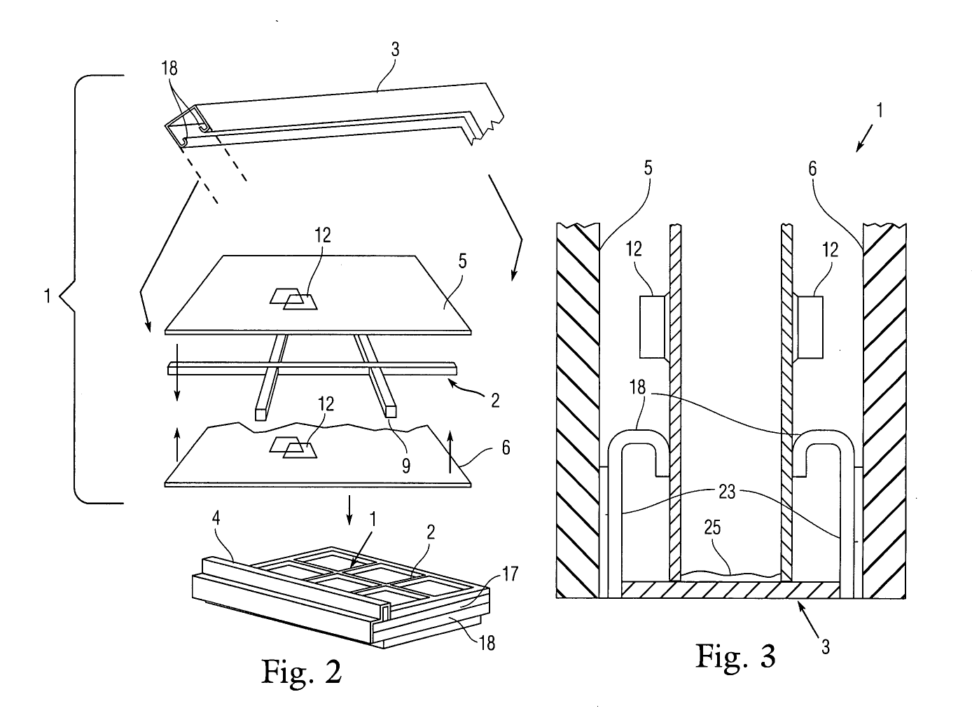

The present invention is a security window insert assembly 1 retrofit to existing insulated window. FIGS. 1-4 are a perspective view, assembly drawing, side cross-section, and top perspective view, respectively, of the security window insert assembly 1 described in the context of a double pane window. The assembly 1 generally comprises a tubular metal grating 2 anchored within a rectangular spacer 3 and suspended between the panes 5, 6 of a double-pane window. With the tubular metal grating 2 inserted into the spacer 3 and seated between the inwardly furled interior edges 18, the panes 5, 6 of glass 5, 6 are then adhered to the outside edges of rectangular spacer 3, preferably with Butyl-rubber seals 23 there between to avoid condensation in the inner airspace. The assembly 1 can fit to any conventional detachable rectangular double pane (or multi-pane) window (here illustrated with double-panes 5, 6). As seen in FIGS. 1 and 2 (bottom inset of FIG. 2) the assembly 1 can then be incorporated into most any conventional double pane (or multi-pane) window slider to prevent break-ins and at the same time add to the aesthetics of the window.

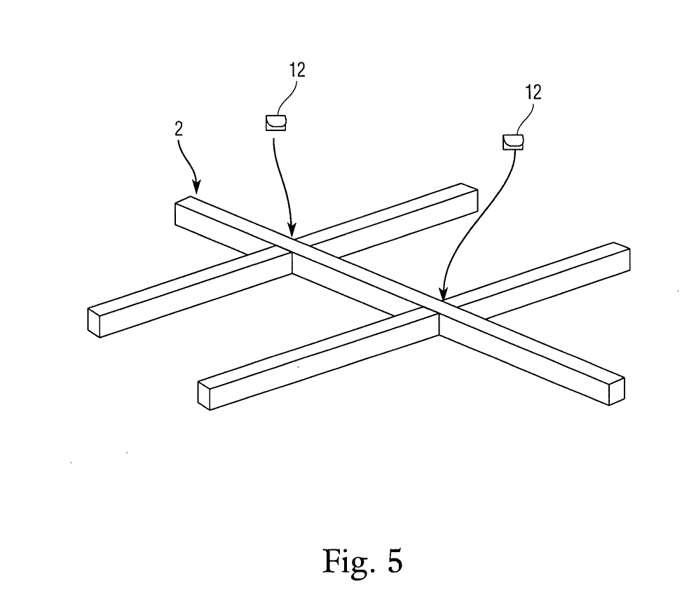

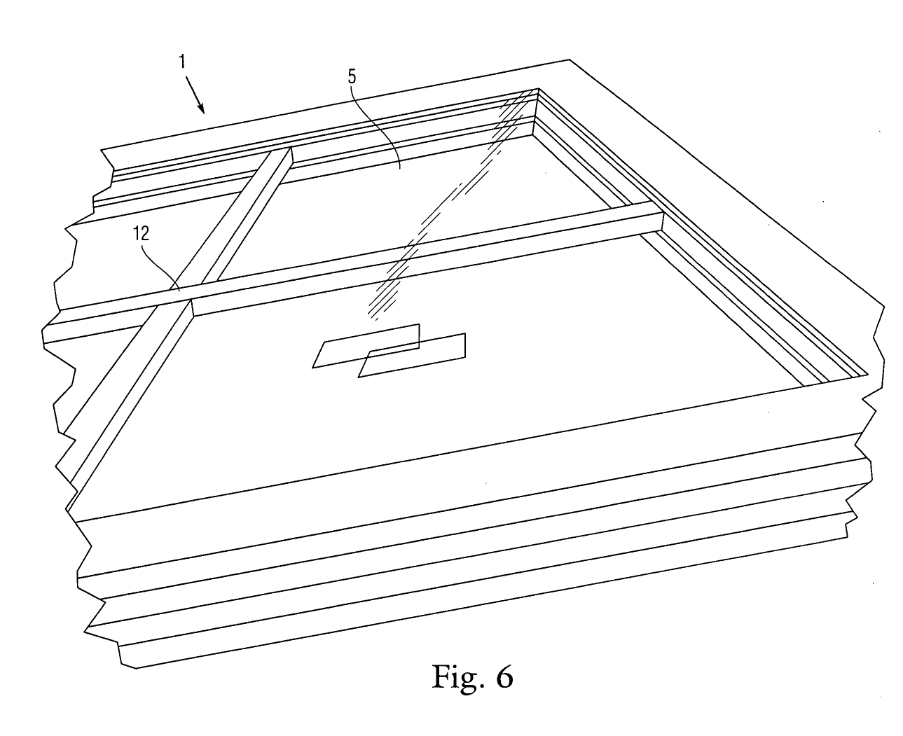

FIG. 5 is an end perspective view of the tubular grating 2, which further comprises one or more horizontal and one or more vertical bars (or struts) integrally joined at their intersection one or more horizontal steel bars and one or more vertical steel bars (the number being somewhat a matter of design choice, although a single vertical and two spaced horizontal provide the most traditional aesthetics for most common double-hung windows). The gridwork 2 of bars are formed from tubular stock having a substantially rectangular cross-section welded at the intersections, and each protrudes to a distal end 9 that is fixedly anchored in the spacer 3. This interior gridwork comprises a matrix of closed tubular steel bars for added strength and security.

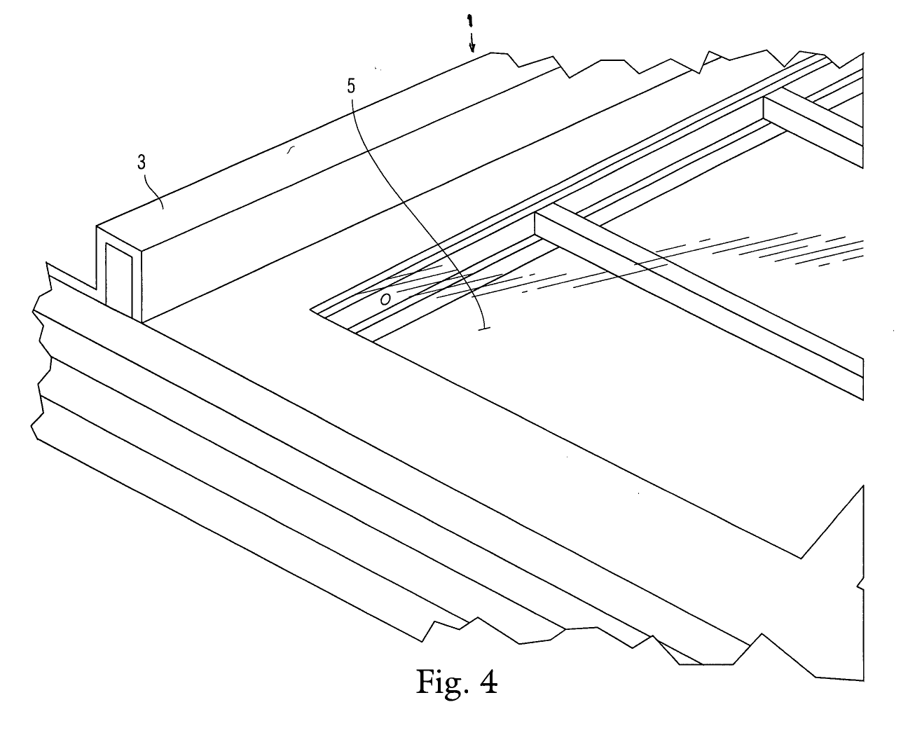

With reference to FIGS. 2 and 3, the rectangular spacer 3 is a fully-framed rectangle with central rectangular aperture, and as shown in FIG. 3 the spacer 3 has a substantially U-shaped cross-section, open inward, and formed with inwardly furled interior edges 18. Although there are many other spacer configurations in conventional double-pane windows, the present security assembly 1 relies on this substantially U-shaped spacer 3 open inward. If desired, an adhesion layer of dessicant 25, such as Butyl-rubber dessicant tape, may be adhered inside the spacer 3 about the entire rectangle.

The tubular grating 2 is anchored inside the spacer 3 at the distal tips, the tips of each bar being press-fit into the U-shaped trough of spacer 3 and held therein by the furled edges 18 of spacer 3.

As best seen in FIG. 3, when laid overtop the top 5 and bottom 6 panes generally conform to the grating 2 and spacer 3 and are sealed there against with rectangular Butyl-rubber seals 23 (or gaskets) and adhesive. This creates an airtight interior space between the panes 5, 6 within which the tubular grating 2 is suspended. The tubular grating 2 is itself hollow and susceptible to internal condensation. However, small pads of dessicant 25 may be positioned inside the trough of the spacer 3 where the bars of grating 2 open, thereby providing absorption for the condensation.

Depending on further field testing it may be necessary to buffer the suspended tubular grating 2 against the panes 5, 6 of glass. This is an optional precaution against damage to the glass from shock or vibration, and can easily be accomplished with rubber buffer pads 12, such that the grating 2 is mounted between the interior surfaces of the panes 5, 6 and any contact of the grating is absorbed by the buffer pads 12.

FIG. 5 is an end perspective view of the grating 2 and buffer pads 12. FIG. 6 is a bottom perspective view of the grating 2 mounted between double pane windows 5, 6. Buffer pads 12 are adhered by adhesive (such as a peel-and-stick adhesive layer) to the grating 2 at the juncture points along the interior gridwork to buffer contact against the inner surfaces of panes 5, 6, also to help secure the grating 2 between the panes 5, 6.

Conventional double-hung double pane windows are approximately 3 feet by 5 feet, with overlapping sliders each formed with a frame enclosing double panes 5, 6. Thus, on conventional double-hung windows both top and bottom sliders would incorporate a security window insert assembly 1. The inner perimeter of the grating 2 is designed to fit the footprint of a slider, to facilitate a tight fit between the panes 5, 6 and the grating 2. The outer perimeter of the grating 2 is dimensioned to fit into a window frame 18. The inserts 3, 4 are dimensioned for a snug fit within a window frame 18. When the sliders are locked together using their existing locking mechanism the adjoining inserts assemblies 1 create a secure and tamper-proof shield against forced entry.

The tubular grating 2 is preferably comprised of steel, the spacer 3 aluminum, and the circular buffer pads 12 formed of silicone rubber or the like. One skilled in the art will understand that any materials possessing an appropriate amount of strength and longevity may be used for the grating 2, inserts 3, 4 and buffer pads 12.

The present design is simple and it can vary in size and shape to fit double pane windows 5, 6 of various dimensions. The assembly 1 can be fit into existing window sliders comprising acrylic, glass, vinyl, or any other suitable material. Additionally the design of the present invention is scalable and can be economically manufactured and sold. The security window insert assembly 1 is relatively lightweight, inexpensive to produce, easy to install during the window manufacturing process within the footprint of existing double pane window sliders, and yet fully tamper proof for security.

To assemble, the buffer pads 12 (if desired) are applied to the grating 2, preferably one on each side at each intersection. The spacer 3 is then attached to the grating 2 around its periphery, such that the grating 2 is securely anchored therein. This may be accomplished (as described above) by applying individual lengths of the spacer 3 together about the grating 2 to form a rectangle and then joining them end-to-end by welding or the like. Alternatively, this is accomplished by bending a single elongate strut notched four times along its length around the rectangular grating 2. Butyl-rubber seals 23 are then adhered around the spacer 3, and the sides of the panes 5, 6 are aligned with the spacer 3, such that the spacer 3 is sandwiched between the interior surfaces of the panes 5, 6, with the grating 2 secured within the spacer 3. Finally, the entire insert assembly 1 is mounted on the interior 17 of the window frame 18, to thereby seal the assembly 1 with the window frame. The insert assembly 1 forms an air-tight seal between the window panes 5, 6. The grating 2 is integral to the window panes 5, 6, firmly anchored within the spacer 3, and provides added security to a home or other structure. The metal grating 2 acts as a security barrier to a burglar who may break the windows and attempt to enter through the window frame 18. The window panes 5, 6 and grating 2 cannot be removed from the exterior of the structure. Moreover, in the event of a fire or other emergency requiring persons to evacuate through the window frame 18 quickly, it is only necessary to open the window.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A security window insert, comprising:
a peripheral rectangular spacer formed with a substantially U-shaped cross-section and open inwardly to define a trough;
a steel grating seated inside said rectangular spacer, said grating comprising a gridwork of horizontal and vertical steel bars fixedly attached at their intersections and each terminating at distal end, the distal ends protruding into the trough of said rectangular spacer.

2. A window slider, comprising a pair of glass panes, and the security window insert of claim 1 aligned with and sandwiched between said glass panes.

3. The window slider according to claim 2, wherein said pair of glass panes are adhered to said spacer on opposing sides thereof such that said spacer is sandwiched between interior surfaces of the panes and the grating is secured within the spacer.

4. The security window insert assembly according to claim 1, wherein said peripheral rectangular spacer is formed with inwardly furled lips for press-fit insertion of said tubular steel grating.

5. The security window insert assembly according to claim 1, wherein said tubular steel grating comprises a gridwork of one or more tubular steel bars and one or more coplanar vertical tubular steel bars all having a rectangular cross-section.

6. The security window insert assembly according to claim 1, wherein said rectangular spacer is formed from four lengths joined end-to-end.

7. The security window insert assembly according to claim 1, wherein said rectangular spacer is formed from a single length having a plurality of notches spaced along its length and bent at the notches into a rectangle.

8. The security window insert assembly according to claim 1, further comprising a plurality of patches of dessicant each adhered inside the trough of said spacer at the distal ends of said gridwork.

9. The security window insert assembly according to claim 1, further comprising a buffer pad adhered on each side of said gridwork at each intersection of said bars.

10. A security window insert assembly retrofit to an existing double pane window comprising:
a peripheral rectangular spacer formed with a substantially U-shaped cross-section and open inwardly to define a trough;
a tubular steel grating comprising a gridwork of one or more horizontal tubular steel bars and one or more coplanar vertical tubular steel bars fixedly attached at their intersections and each terminating at distal end, said distal ends protruding into the trough of said rectangular spacer; and
a pair of rectangular seals conforming to said rectangular spacer and adhered on each side; and
a pair of glass panes aligned with and adhered to said spacer on opposing sides thereof such that said spacer is sandwiched between the interior surfaces of the panes and the grating is secured within the spacer.

11. The security window insert assembly according to claim 10, wherein said peripheral rectangular spacer is formed with inwardly furled lips for press-fit insertion of said tubular steel grating.

12. The security window insert assembly according to claim 10, wherein said tubular steel grating comprises a gridwork of one or more tubular steel bars and one or more coplanar vertical tubular steel bars all having a rectangular cross-section.

13. The security window insert assembly according to claim 10, wherein said peripheral rectangular spacer is formed from four lengths joined end-to-end.

14. The security window insert assembly according to claim 10, wherein said peripheral rectangular spacer is formed from a single length having a plurality of notches spaced along its length and bent at the notches into a rectangle.

15. The security window insert assembly according to claim 10, further comprising a plurality of patches of dessicant each adhered inside the trough of said spacer at the distal ends of said gridwork.

16. The security window insert assembly according to claim 10, further comprising a buffer pad adhered on each side of said gridwork at each intersection of said bars.

17. A method for affixing a security window insert assembly into a double hung window, comprising steps of:
attaching a rectangular spacer formed with a substantially U-shaped cross-section about a tubular steel grating comprising a gridwork of one or more horizontal tubular steel bars and one or more coplanar vertical tubular steel bars fixedly attached at their intersections and each terminating at distal end, by press-fitting said distal ends into the trough of said rectangular spacer;
attaching a pair of rectangular seals one on each side of said rectangular spacer;
affixing a pair of glass panes on either side of said spacer such that said spacer and seals are sandwiched between the interior surfaces of the panes and the grating is secured within the spacer.
